(19) United States
(12) Patent Application Publication
(10) Pub. No.: US 2019/0323112 A1
(43) Pub. Date: Oct. 24, 2019

(54) COMPOSITE BOND COATS

(71) Applicants: Rolls-Royce High Temperature Composites, Inc., Cypress, CA (US); Rolls-Royce Corporation, Indianapolis, IN (US)

(72) Inventors: Sungbo Shim, Irvine, CA (US); Li Li, Carmel, IN (US)

(21) Appl. No.: 16/388,087

(22) Filed: Apr. 18, 2019

Related U.S. Application Data
(60) Provisional application No. 62/661,129, filed on Apr. 23, 2018.

(51) Int. Cl. C23C 4/10; C23C 4/134; C04B 35/622; C04B 35/565; C04B 35/587; C04B 41/50; C04B 41/87; C04B 41/00; C04B 41/45

(52) U.S. Cl. CPC C23C 4/10; C23C 4/134; C04B 35/62222; C04B 35/565; C04B 35/587; C04B 41/5059; C04B 2235/5436; C04B 41/87; C04B 41/009; C04B 41/4545; C04B 2235/3826; C04B 2235/3873; C04B 2235/528; C04B 41/5066

(57) ABSTRACT

A composite bond coat may include a matrix and a reinforcing component. The matrix may be formed from silicon-based particles, and the reinforcing component includes silicon-based ceramic particles. The composite bond coat may be formed by introducing a precursor composition into a plume generated by a thermal spray gun to generate a thermal spray stream. The thermal spray stream may be directed at a major surface defined by a substrate of the component to form the composite bond coat. The precursor composition includes the matrix component and the reinforcing component.

This application claims the benefit of U.S. Provisional Application No. 62/661,129, filed Apr. 23, 2018, which is incorporated herein by reference in its entirety.

### TECHNICAL FIELD

The present disclosure generally relates to bond coats and systems and techniques for forming bond coats, for example, bond coats for high-performance systems including rotating components.

### BACKGROUND

The components of high-performance systems, such as, for example, turbine or compressor components, operate in severe environments. For example, turbine blades, vanes, blade tracks, and blade shrouds exposed to hot gases in commercial aeronautical engines may experience metal surface temperatures of about 1000° C. High-performance systems may include rotating components, such as blades, rotating adjacent a surrounding structure, for example, a shroud.

One or more components of high-performance systems may be provided with barrier layers to maintain the integrity of the components against the operating environments. A bond coat may be provided between a substrate of a component and a barrier layer to promote bonding and retention of the barrier layers to the substrate.

### SUMMARY

In some examples, the disclosure describes a high-performance component including a substrate defining a major surface and a composite bond coat on the major surface of the substrate. The composite bond coat includes a matrix and a reinforcing component in the matrix. The matrix is formed from silicon-based particles having an average particle size in a range from about 10 μm to about 30 μm. The reinforcing component includes silicon-based ceramic particles having an average particle size in a range from about 5 μm to about 20 μm.

In some examples, the disclosure describes a technique for forming a composite bond coat on a high-performance component. The technique includes introducing a precursor composition into a plume generated by a thermal spray gun to generate a thermal spray stream. The precursor composition includes a matrix component and a reinforcing component. The matrix component includes silicon-based particles having an average particle size in a range from about 10 μm to about 30 μm. The reinforcing component includes silicon-based ceramic particles having an average particle size in a range from about 5 μm to about 20 μm. The technique includes directing the thermal spray stream at a major surface defined by a substrate of the high-performance component to form the composite bond coat.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic cross-sectional diagram illustrating a high-performance component including a substrate and a composite bond coat including a reinforcing component in a matrix.

FIG. 2 is a conceptual and schematic cross-sectional diagram illustrating a high-performance component including a substrate and a composite bond coat including a graded distribution of particles of a reinforcing component in a matrix.

FIG. 3 is a conceptual and schematic cross-sectional diagram illustrating a high-performance component including a substrate and a composite bond coat including a reinforcing component including crushed particles.

FIG. 4 is a conceptual and schematic block diagram illustrating an example system for forming a composite bond coat on a substrate of a high-performance component.

FIG. 5 is a flow diagram illustrating an example technique for forming a composite bond coat on a substrate of a high-performance component.

### DETAILED DESCRIPTION

The disclosure describes example composite bond coats including a matrix and a reinforcing component and techniques for forming example composite bond coats on an example high-performance component. The matrix may be formed from silicon-based particles, and the reinforcing component includes silicon-based ceramic particles. An example technique may include introducing a precursor composition into a plume generated by a thermal spray gun to generate a thermal spray stream. The thermal spray stream is directed at a major surface defined by a substrate of the high-performance component to form the composite bond coat. The precursor composition includes the matrix component and the reinforcing component. The matrix may be formed from silicon-based particles having an average particle size in a range from about 10 μm to about 30 μm. The reinforcing component may include silicon-based ceramic particles having an average particle size in a range from about 5 μm to about 20 μm.

Example composite bond coats according to the disclosure may have a relatively higher creep resistance compared to bond coats that do not include a reinforcing component such as silicon-based ceramic particles. For example, one or more of the volume fraction or concentration, average particle size, and particle morphology of particles in composite bond coats may influence the creep resistance of the composite bond coat. Further, using silicon-based particles having an average particle size in a range from about 10 μm to about 30 μm to form a matrix, and using silicon-based ceramic particles having an average particle size in a range from about 5 μm to about 20 μm as a reinforcing component may reduce or prevent blockages or disruptions in thermal spraying and may promote the formation of a relatively uniform coating thickness. Example techniques according to the disclosure may also reduce or avoid the use of pre-coating steps such as surface preparation prior to forming a bond coat.

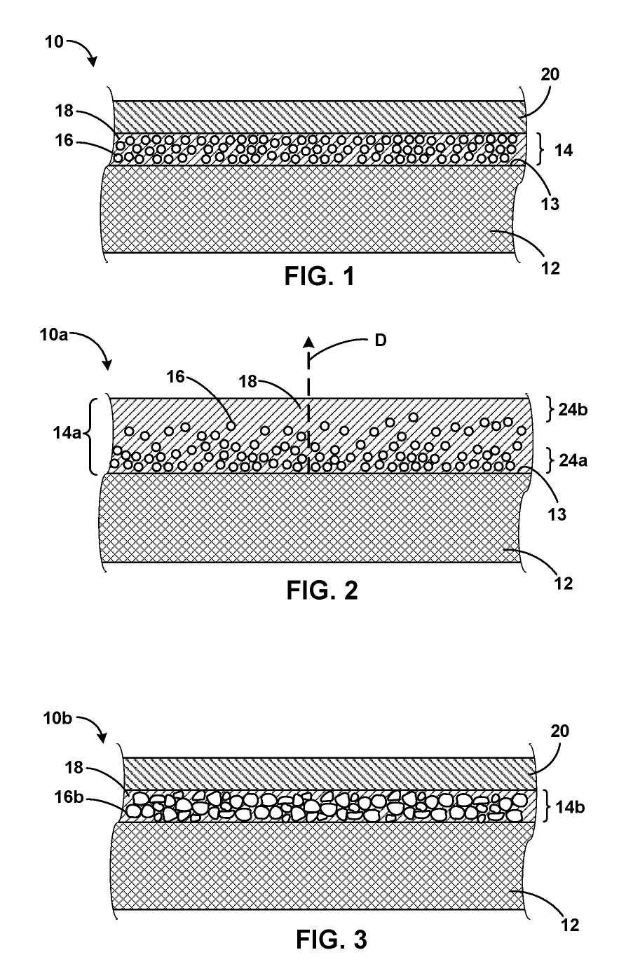

FIG. 1 is a conceptual and schematic cross-sectional diagram illustrating a high-performance component 10 including a substrate 12, a composite bond coat 14 including a reinforcing component 16 in a matrix 18 on substrate 12, and at least one additional layer 20 on composite bond coat 14.

High-performance component 10 may include a mechanical component operating at relatively high conditions of temperature, pressure, or stress, for example, a component of a turbine, a compressor, or a pump. In some examples, high-performance component 10 includes a gas turbine engine, for example, an aeronautical, marine, or land-based gas turbine engine. In some examples, high-performance component 10 includes a component of a gas turbine engine, for example, a blade, a vane, an airfoil, a combustor liner, a shroud, or the like.

Substrate 12 may include a ceramic-based substrate, for example, a substrate including ceramic or ceramic matrix composite (CMC). Suitable ceramic materials, may include, for example, a silicon-containing ceramic, such as silica (SiO₂), silicon carbide (SiC); silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In some examples in which substrate 12 includes a ceramic, the ceramic may be substantially homogeneous.

In examples in which substrate 12 includes a CMC, substrate 12 may include a matrix material and a reinforcement material. The matrix material may include, for example, silicon metal or a ceramic material, such as silicon carbide (SiC), silicon nitride (Si₃N₄), an aluminosilicate, silica (SiO₂), a transition metal carbide or silicide (e.g., WC, Mo₂C, TiC, MoSi₂, NbSi₂, TiSi₂), or other ceramics described herein. The CMC may further include a continuous or discontinuous reinforcement material. For example, the reinforcement material may include discontinuous whiskers, platelets, fibers, or particulates. Additionally, or alternatively, the reinforcement material may include a continuous monofilament or multifilament two-dimensional or three-dimensional weave. In some examples, the reinforcement material may include carbon (C), silicon carbide (SiC), silicon nitride (Si₃N₄), an aluminosilicate, silica (SiO₂), a transition metal carbide or silicide (e.g. WC, Mo₂C, TiC, MoSi₂, NbSi₂, TiSi₂), another ceramic material described herein, or the like.

In some examples, the composition of the reinforcement material is the same as the composition of the matrix material. For example, a matrix material comprising silicon carbide may surround a reinforcement material including silicon carbide whiskers. In other examples, the reinforcement material includes a different composition than the composition of the matrix material, such as aluminosilicate fibers in an alumina matrix, or the like. One composition of substrate 12 that includes a CMC is a reinforcement material of silicon carbide continuous fibers embedded in a matrix material of silicon carbide. In some examples, substrate 12 includes a SiC—SiC CMC. In some examples in which substrate 12 includes CMC, the CMC may include a plurality of plies of reinforcing fibers.

In some examples, substrate 12 may be provided with one or more coatings, for example, on a major surface 13 defined by substrate 12. In some examples, substrate 12 may be provided with composite bond coat 14 on major surface 13, as shown in FIG. 1, or on an intermediate coating on major surface 13. Component 10 also may include at least one additional layer 20 on composite bond coat 14.

Composite bond coat 14 (also referred to as bond coat 14) may be substrate 12 to promote adhesion between substrate 12 and at least one additional layer 20. At least one additional layer 20 may include, for example, at least one barrier coating such as an environmental or a thermal barrier coating, an abradable coating, or other coatings, layers, or components. At least one additional layer 20 may include at least one of a thermal barrier coating (TBC) or an environmental barrier coating (EBC) to reduce surface temperatures and prevent migration or diffusion of molecular, atomic, or ionic species from or to substrate 12. The TBC or EBC may allow use of high-performance component 10 at relatively higher temperatures compared to high-performance component 10 without the TBC or EBC, which may improve efficiency of high-performance component 10.

Example EBCs include, but are not limited to, mullite; glass ceramics such as barium strontium alumina silicate (BaOₓ—SrO₁₋ₓ—Al₂O₃-2SiO₂; BSAS), barium alumina silicate (BaO—Al₂O₃-2SiO₂; BAS), calcium alumina silicate (CaO—Al₂O₃-2SiO₂), strontium alumina silicate (SrO—Al₂O₃-2SiO₂; SAS), lithium alumina silicate (Li₂O—Al₂O₃-2SiO₂; LAS) and magnesium alumina silicate (2MgO-2Al₂O₃-5SiO₂; MAS); rare earth oxides; rare earth silicates; or the like. An example rare earth silicate for use in an environmental barrier coating is ytterbium silicate, such as ytterbium monosilicate or ytterbium disilicate. In some examples, an environmental barrier coating may be substantially dense, e.g., may include a porosity of less than about 5 vol. % to reduce migration of environmental species, such as oxygen or water vapor, to substrate 12.

Examples of TBCs, which may provide thermal insulation to the CMC substrate to lower the temperature experienced by the substrate, include, but are not limited to, insulative materials such as ceramic layers including zirconia or hafnia. In some examples, the TBC may include multiple layers. The TBC or a layer of the TBC may include a base oxide of either zirconia or hafnia and a first rare earth oxide of yttria. For example, the TBC or a layer of the TBC may consist essentially of zirconia and yttria. As used herein, to “consist essentially of” means to consist of the listed element(s) or compound(s), while allowing the inclusion of impurities present in small amounts such that the impurities do no substantially affect the properties of the listed element or compound.

In some examples, the TBC or a layer of the TBC may include a base oxide of zirconia or hafnia and at least one rare earth oxide, such as, for example, oxides of Lu, Yb, Tm, Er, Ho, Dy, Gd, Tb, Eu, Sm, Pm, Nd, Pr, Ce, La, Y, Sc. For example, a TBC or a TBC layer may include predominately (e.g., the main component or a majority) the base oxide zirconia or hafnia mixed with a minority amounts of the at least one rare earth oxide. In some examples, a TBC or a TBC layer may include the base oxide and a first rare earth oxide including ytterbia, a second rare earth oxide including samaria, and a third rare earth oxide including at least one of lutetia, scandia, ceria, neodymian, europia, and gadolinia. In some examples, the third rare earth oxide may include gadolinia such that the TBC or the TBC layer may include zirconia, ytterbia, samaria, and gadolinia. The TBC or the TBC layer may optionally include other elements or compounds to modify a desired characteristic of the coating, such as, for example, phase stability, thermal conductivity, or the like. Example additive elements or compounds include, for example, rare earth oxides. The inclusion of one or more rare earth oxides, such as ytterbia, gadolinia, and samaria, within a layer of predominately zirconia may help decrease the thermal conductivity of a TBC layer, e.g., compared to a TBC layer including zirconia and yttria. While not wishing to be bound by any specific theory, the inclusion of ytterbia, gadolinia, and samaria in a TBC layer may reduce thermal conductivity through one or more mechanisms, including phonon scattering due to point defects and grain boundaries in the zirconia crystal lattice due to the rare earth oxides, reduction of sintering, and porosity.

In some examples in which at least one additional layer 20 includes both the TBC and the EBC, either one of the TBC or the EBC may be disposed adjacent bond coat 14 or substrate 12, and the other one of the TBC or the EBC may be disposed opposed to and away from adjacent bond coat 14 or substrate 12. In some examples in which high-performance component 10 includes bond coat 14, and in which at least one additional layer 20 includes both the TBC and the EBC, the TBC may be between bond coat 14 and the EBC, or the EBC may be between bond coat 14 and the TBC. At least one layer additional 20 (including one or more of the EBC, the TBC, or other layers) may be applied by thermal spraying, including, plasma spraying, high velocity oxygen fuel (HVOF) spraying, low vapor plasma spraying; plasma vapor deposition (PVD), including electron-beam PVD (EB-PVD), direct vapor deposition (DVD), and cathodic arc deposition; chemical vapor deposition (CVD); slurry process deposition; sol-gel process deposition; electrophoretic deposition; or the like. One or both of bond coat 14 and at least one additional layer 20 may be at least partially disposed or formed over major surface 13 of substrate 12.

In some examples, at least one additional layer 20 may include an abradable layer. The abradable layer may include any suitable abradable composition capable of being abraded by a rotating component, for example, a blade tip. The abradable composition may exhibit a hardness that is relatively lower than a hardness of a portion of the rotating component such that the portion of the rotating component can abrade the abradable composition by contact. The abradable composition may include at least one of aluminum oxide, mullite, zirconium oxide, silicon metal, silicon alloy, a transition metal nitride, a transition metal boride, a rare earth oxide, a rare earth silicate, zirconium oxide, a stabilized zirconium oxide (for example, yttria-stabilized zirconia), a stabilized hafnium oxide (for example, yttria-stabilized hafnia), or barium-strontium-aluminum silicate, or mixtures and combinations thereof. In some embodiments, the abradable coating includes at least one silicate, which may refer to a synthetic or naturally-occurring compound including silicon and oxygen. Suitable silicates include, but are not limited to, rare earth disilicates, rare earth monosilicates, barium strontium aluminum silicate, and mixtures and combinations thereof.

In some examples, at least one additional layer 20 may be on bond coat 14, and bond coat 14 may retain at least one additional layer 20 on high-performance component 10. For example, in the absence of bond coat 14, at least one additional layer 20 may exhibit relatively higher spallation, cracking, or peeling off from substrate 12. The presence of bond coat 14 may promote the adhesion or retention of at least one additional layer 20 on substrate 12 or high-performance component 10. In some examples, bond coat 14 may include a component that is substantially the same or is substantially compatible with at least one component of substrate 12 or of at least one additional layer 20, to promote adhesion or retention of bond coat 14 to substrate 12 or of at least one additional layer 20 to bond coat 14. For example, one or both of substrate 12 or at least one additional layer 20 may include elemental silicon, and bond coat 14 may also include silicon.

Bond coat 14 may include silicon metal, silicon alloys, silicon ceramic, silica, a silicide, or the like. In some examples, bond coat 14 may include transition metal nitrides, carbides, or borides. Bond coat 14 may further include other ceramics, other elements, or compounds, such as silicates of rare earth elements (i.e., a rare earth silicate) including Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium), La (lanthanum), Y (yttrium), or Sc (scandium).

Bond coat 14 includes matrix 18. In some examples, matrix 18 may include silicon-based particles. In some examples, matrix 18 may not include discrete particles, and may include fused particles. In some examples, matrix 18 is formed (for example, by thermal spraying) from silicon-based particles. In some examples, the silicon-based particles consist of or consist essentially of elemental or metallic silicon. The silicon-based particles used to form matrix 18 may have any suitable shape, for example, substantially spherical or spheroidal, irregular, crushed, or other shapes. In some examples, silicon-based particles used to form matrix 18 have a substantially spherical or spheroidal shape. For example, in contrast with non-spheroidal or asymmetric particles, using substantially spherical or spheroidal particles may promote the formation of a relatively uniform matrix 18 or bond coat 14 having a uniform thickness. For example, spherical or spheroidal particles may be substantially uniformly distributed in a plume of a thermal spray such that each pass of spray results in a substantially uniform layer. In some examples, spheroidal silicon particles may offer a relatively better shadowing effect, which may protect SiC (or other silicon alloy) particles from decomposing in a plasma flame or spray plume during a thermal spray process. In examples in which silicon-based particles 18 partly or substantially retain their geometry after the spraying, spherical or spheroidal particles may exhibit improved packing compared to non-spheroidal particles or help in reducing porosity if sintered. In some examples, silicon-based particles 18 may exhibit a multi-modal particle size distribution, which may exhibit improved packing or reduced porosity if sintered, if the particles retain their identity in bond coat 14, or may exhibit a more uniform distribution in the plume of a thermal spray, ultimately resulting in a more uniform bond coat 14.

In some such examples, silicon-based particles used to form matrix 18 may not retain their initial individual or discrete shapes, and may melt and fuse to form a substantially uniform matrix 18. For example, matrix 18 may be substantially free from discrete silicon-based particles. In some examples, matrix 18 may form a continuous matrix with reinforcing component 16 dispersed or distributed in matrix 18. In other examples, matrix 18 may be discontinuous, and may define continuous pockets or regions dispersed or distributed in bond coat 14.

The silicon-based particles used to form matrix 18 may have an average particle size in a range from about 10 μm to about 30 μm. Forming matrix 18 from silicon-based particles having an average size smaller than 10 μm or greater than 30 μm may be relatively more difficult than forming matrix 18 from particles having an average particle size in a range from about 10 μm to about 30 μm. For example, silicon-based particles having an average particle size greater than 30 μm may not form a continuous or uniform matrix 18 or provide bond coat 14 with a uniform thickness. If the size is too large, for example, greater than 30 μm, silicon particles may overshadow SiC (or another silicon-based ceramic) particles, which may lead to lower melting of silicon-based ceramic particles, which may reduce concentration of silicon-based ceramic in bond coat 14 below an acceptable threshold. Silicon-based particles having an average particle size smaller than 10 μm may agglomerate during coating or spraying used to form bond coat 14, disrupting the thermal spraying process, forming a non-uniform coating, or both. If the size is too small, for example, less than 10 μm, the particles may agglomerate and be hard to feed, resulting in a relatively low deposition rate. Smaller sized silicon particles may also provide a relatively lower shadowing effect, which may not be sufficient to protect silicon-based ceramic particles in a thermal spray plume from decomposing. Thus, a size range of about 10 μm to about 30 μm may yield an acceptable quality of bond coat 14 with a reasonable deposition rate.

Bond coat 14 also includes reinforcing component 16. Reinforcing component 16 includes silicon-based ceramic particles. In some examples, reinforcing component includes at least one of SiC or Si₃N₄. In some examples, reinforcing component 16 includes both SiC and Si₃N₄, for example, a first plurality of particles including SiC, and a second plurality of particles including Si₃N₄. In some examples, reinforcing component 16 consists of or consists essentially of SiC particles, and bond coat 14 is substantially free of non-SiC particles after formation of bond coat 14 (i.e., after the silicon-based particles have melted or sintered to form matrix 18). In some examples, reinforcing component 16 consists of or consists essentially of Si₃N₄ particles, and bond coat 14 is substantially free of non-Si₃N₄ particles after formation of bond coat 14 (i.e., after the silicon-based particles have melted or sintered to form matrix 18). Reinforcing component 16 remains as a second phase within bond coat 14, and is distinct from matrix 18. For example, particles used to form reinforcing component 16 may substantially retain their distinct identity in bond coat 14. The second phase may be discontinuous.

In some examples, reinforcing component 16 is substantially uniformly dispersed or distributed in matrix 18 in bond coat 14, as shown in FIG. 1. For example, a volume fraction of reinforcing component 16 may be substantially the same (for example, less than 5% of a difference in the volume fraction) for a first portion of bond coat 14 as that for an arbitrarily selected second portion of bond coat 14. In other examples, reinforcing component 16 is distributed with a graded distribution, as shown in FIG. 2.

FIG. 2 is a conceptual and schematic cross-sectional diagram illustrating a high-performance component 10a including substrate 12 and composite bond coat 14a including a graded distribution of particles of reinforcing component 16 in matrix 18. Thus, bond coat 14a may include a graded distribution of reinforcing component 16 in a direction (represented by an arrow D in FIG. 2) normal to and away from major surface 13 defined by substrate 12. A concentration (for example, volume fraction, or concentration by weight) of reinforcing component 16 is greater in a first region 24a of bond coat 14a adjacent substrate 12 than in a second region 24b of bond coat 14 opposing major surface 13 of substrate 12. The concentration of reinforcing component 16 may define a suitable linear or non-linear gradient. In some examples, substantially no reinforcing component may be present in second region 24b, such that second region 24b substantially only includes elemental silicon. In some examples, the increased concentration of silicon in second region 24b opposing major surface 13 may form a silicon scale on the surface, or otherwise promote bonding of additional layers to a major surface of bond coat 14 opposing major surface 13. Providing such a gradient distribution may also reduce or prevent diffusion of impurities across bond coat 14. For example, a relatively low Si content near or adjacent major surface 13 of substrate 12 may prevent impurities in substrate 12 from diffusing out, while a higher Si content toward or adjacent an outermost region of bond coat 14, for example, opposing major surface 13, may promote formation of thermally grown oxide on bond coat 14.

As shown in FIGS. 1 and 2, in some examples, reinforcing component 16 may include substantially spherical or spheroidal particles. In some examples, reinforcing component 16 may consist essentially of or consist of substantially spherical or spheroidal particles. For example, bond coat 14 may be substantially free of non-spheroidal particles.

FIG. 3 is a conceptual and schematic cross-sectional diagram illustrating a high-performance component 10b including substrate 12 and a composite bond coat 14b including a reinforcing component 16b including crushed particles. Reinforcing component 16b may include (in addition to, or instead of, spheroidal particles) particles having a fused and crushed morphology, for example, crushed irregular particles. In some examples, the silicon ceramic particles in reinforcing component 16b consist essentially of or consist of crushed irregular particles. The crushed irregular particles may have an average particle size substantially the same as the particle size described with reference to spheroidal particles. Reinforcing component 16b in bond coat 14b may be distributed in matrix 18 similar to the manner described with reference to FIGS. 1 and 2. For example, reinforcing component 16b may be substantially uniformly distributed in matrix 18, as shown in FIG. 3. In other examples, reinforcing component 16b may be distributed in a graded distribution, in a manner similar to that described with reference to FIG. 2.

The average particle size of a respective individual particle of reinforcing component 16 or 16b is an average of different diameters passing through a geometric center of the respective individual particle. In the case of a spheroidal particle, the different diameters for an individual particle may be relatively close or narrowly distributed. In the case of a non-spheroidal particle, the different diameters for an individual particle may be relatively widely distributed. In either case, a predetermined number of diameters may be measured in predetermined directions, and average to obtain an average particle size for an individual particle of reinforcing component 16 or 16b.

In some examples, the average particle sizes of individual particles may itself be narrowly distributed, such that all particles of reinforcing component 16 or 16b have substantially the same size, for example, as shown in FIGS. 1 and 2. In other examples, the average particle sizes of individual particles may be relatively widely distributed, so that reinforcing component 16 or 16b may include particles defining a predetermined particle size distribution.

The average particle sizes of all individual particles or a sample of particles of reinforcing component 16 or 16b may itself be averaged to obtain a population average particle size of all particles of reinforcing component 16 or 16b. Reinforcing component 16 described with reference to FIGS. 1 and 2, or reinforcing component 16b described with reference to FIG. 3, may include silicon-based ceramic particles having a (population) average particle size in a range from about 5 μm to about 20 μm. For example, particles of silicon-based ceramic having an average particle size greater than 20 μm may not form a uniform bond coat 14. For example, if the average particle size is greater than 20 μm, the particles may only partially or incompletely melt, resulting in non-uniformity. Silicon-based ceramic particles having an average particle size smaller than 5 μm may agglomerate during coating or spraying used to form bond coat 14. In some examples, if the size is too small, for example, less than 5 μm, the silicon-based ceramic particles may get overheated in a thermal spray plume during spraying, which may promote decomposing.

Bond coat 14 (or 14a or 14b) may have any suitable relative concentration of reinforcing component 16 or 16b relative to matrix 18. In some examples, bond coat 14, 14a, or 14b includes at least 50% by weight of reinforcing component 16 or 16b. For example, bond coat 14, 14a, or 14b may include reinforcing component 16 or 16b in a range of about 50% to about 95% by weight. In some examples, bond coat 14, 14a, or 14b includes reinforcing component 16 or 16b at a concentration of about 80% by weight. In some examples, bond coat 14a includes a graded distribution of concentration of reinforcing component 16 or 16b, for example, in a range of 60% to 100% by weight in region 24a adjacent major surface 13, and in a range of 0% to 50% by weight in region 24b opposed to major surface 13, with intermediate concentrations between regions 24a and 24b of bond coat 14a. In some examples, region 24a includes reinforcing component 16 or 16b in a range of 85% to 100% by weight. In some examples, bond coat 14, 14a, or 14b includes at least 50% by volume of total silicon in elemental Si and in silicon alloy (for example, SiC). In some examples, an outermost layer of bond coat 14, 14a, or 14b, for example, a layer opposing major surface 13, for example, second region 24b, may include at least 50% by volume of silicon. In some examples, first region 24a adjacent major surface 13 may include less than 20% by volume, or less than 10% by volume, of total silicon in elemental Si and in silicon alloy.

Bond coat 14, 14a, or 14b may define any suitable thickness in direction D. In some examples, bond coat 14, 14a, or 14b defines a thickness in direction D normal to major surface 13 of substrate 12 in a range from about 0.0127 mm (0.5 mils) to about 0.254 mm (10 mils). In some examples, the thickness of bond coat 14, 14a, or 14b is substantially uniform along major surface 13.

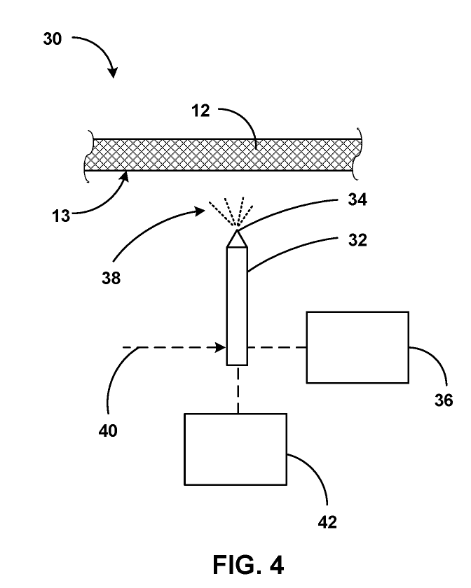

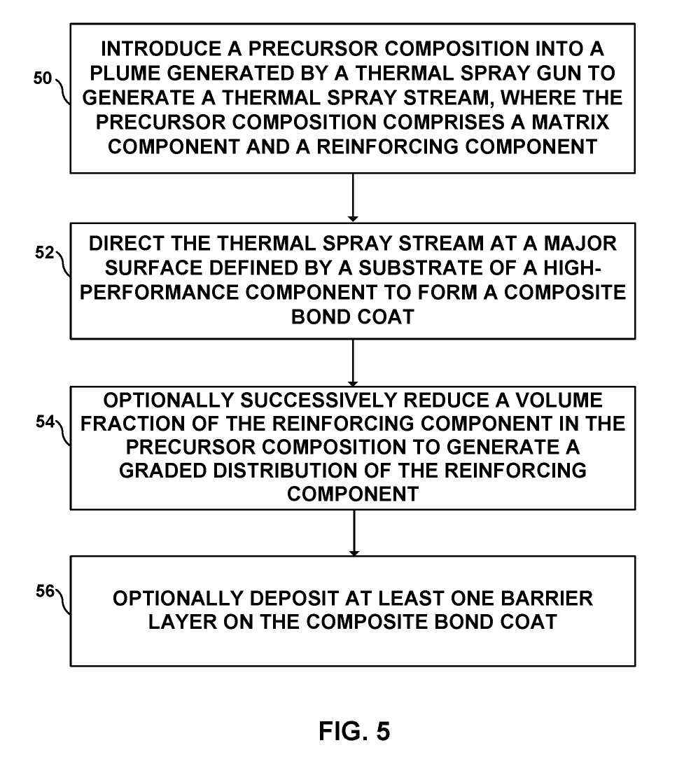

Bond coat 14 may be applied by thermal spraying, including, plasma spraying, high velocity oxygen fuel (HVOF) spraying, low vapor plasma spraying; plasma vapor deposition (PVD), including electron-beam PVD (EB-PVD), direct vapor deposition (DVD), and cathodic arc deposition; chemical vapor deposition (CVD); slurry process deposition; sol-gel process deposition; electrophoretic deposition; or the like. In some examples, bond coat 14 is applied using example systems and techniques according to the disclosure, for example, example systems and techniques described with reference to FIGS. 4 and 5.

FIG. 4 is a conceptual and schematic block diagram illustrating an example system 30 for forming composite bond coat 14, 14a, or 14b on substrate 12 of high-performance component 10, 10a, or 10b. While example system 40 described with reference to FIG. 4 may be used to prepare example articles described with reference to FIGS. 1 to 3, example system 30 may be used to prepare any example articles according to the disclosure.

System 30 includes a spray gun 32 having a nozzle 34 coupled to a reservoir 36. Reservoir 36 holds a spray precursor composition sprayed as a spray stream 38 through nozzle 34. System 30 may further include a feed stream 40 including a working fluid or a gas, for example, a fluid or gas ignitable or energizable to form a plasma, or a fluid including a fuel ignitable to form a high velocity oxygen fuel stream. System 30 may include an igniter (not shown) to ignite the plasma or fuel stream. System 30 may include a platform, an articulating or telescoping mount, a robotic arm, or the like to hold, orient, and move spray gun 32 or substrate 12. Spray gun 32 may be held, oriented, moved, or operated manually by an operator, or semi-automatically or automatically with the assistance of a controller.

For example, system 30 may include a controller 42 to control the operation of spray gun 32. Controller 42 may include control circuitry to control one or more of the flow rate of the spray composition or of feed stream 40, the pressure, temperature, nozzle aperture, spray diameter, or the relative orientation, position, or distance of nozzle 34 with respect to substrate 12. The control circuitry may receive control signals from a processor or from an operator console. In some examples, system 30 may include a booth or a chamber (not shown) at least partly surrounding spray gun 34 and substrate 12 to shield the environment from spray stream 38 and from the operating conditions of the spraying. In some such examples, one or both of reservoir 36 or controller 42 may be outside the booth or chamber. System 30 may be used to form bond coat 14, 14a, or 14b on substrate 12 according to an example technique described with reference to FIG. 5.

FIG. 5 is a flow diagram illustrating an example technique for forming composite bond coat 14, 14a, or 14b on substrate 12 of high-performance component 10, 10a, or 10b. The technique of FIG. 5 will be described with respect to high-performance component 10, 10a, or 10b of FIGS. 1 to 3, and system 30 of FIG. 4. However, the technique of FIG. 5 may be used to form other articles, and high-performance component 10, 10a, or 10b of FIGS. 1 to 3 may be formed using other techniques and systems.

The example technique of FIG. 5 includes thermal spraying a precursor composition at substrate 12 of high-performance component 10 to form bond coat 14, 14a, or 14b. For example, the example technique may include thermal spraying by introducing a precursor composition into a plume generated by thermal spray gun 32 to generate thermal spray stream 38 (50). The precursor composition comprises a matrix component and reinforcing component 16 or 16b, as described elsewhere in the disclosure. For example, the matrix component may include silicon-based particles having an average particle size in a range from about 10 μm to about 30 μm, and eventually forms matrix 18. In some examples, reinforcing component 16 or 16b includes silicon ceramic particles having an average particle size in a range from about 5 μm to about 20 μm. Introducing the precursor composition into the plume (for example, an energized flow stream or an ignited plasma stream) may result in at least partial fusion or melting of the precursor composition, and directing or propelling the precursor composition toward substrate 12, for example, at major surface 13. The propelled precursor composition impacts substrate 12 to form a portion of a coating, for example, of bond coating 14, 14a, or 14b.

The example technique includes directing thermal spray stream 38 at major surface 13 defined by substrate 12 of high-performance component 10, 10a, or 10b to form bond coat 14, 14a, or 14b (52). The thermal spraying including the introducing (50) and the directing (52) may include any spraying technique suitable for spraying the precursor composition, for example, at least one of air plasma spraying, low vapor plasma spraying, suspension plasma spraying, or high velocity oxygen fuel spraying.

The concentration of reinforcing component 16 or 16b relative to the matrix component in the composition introduced in the plume may be set or maintained at any suitable concentration, for example, a concentration that results in a predetermined relative concentration of reinforcing component 16 or 16b relative to matrix 18 in bond coat 14, 14a, or 14b. In some examples, the relative concentration may be substantially constant to result in a substantially uniform distribution of reinforcing component 16 or 16b along a thickness of matrix 18 formed from the matrix component.

In other examples, the relative concentration may be varied to result in a graded distribution of reinforcing component 16 or 16b. For example, the example technique of FIG. 5 may optionally include successively reducing a volume fraction of reinforcing component 16 or 16b in the precursor composition to generate a graded distribution of reinforcing component 16 or 16b in composite bond coat 14a in a direction D normal to and away from substrate 12 (54). The volume fraction of reinforcing component 16 or 16b may be reduced by one or both of reducing an amount or flow rate of reinforcing component 16 or 16b introduced in the plume or increasing an amount or flow rate of the matrix component in the plume.

Layer 20 may be formed after forming bond coat 14, 14a, or 14b. For example, the example technique of FIG. 5 may optionally include depositing at least one barrier layer 20 on bond coat 14, 14a, or 14b (58). Depositing at least one barrier layer 20 (58) may include at least one of thermal spraying, plasma spraying, physical vapor deposition, chemical vapor deposition, or any other suitable technique.

Thus, the example technique of FIG. 5 may be used to form bond coat 14, 14a, or 14b on major surface 13 of substrate 12.

While thermal spraying may be used to form bond coat 14, 14a, or 14b, other techniques may also be used to form bond coat 14, 14a, or 14b. For example, slurry deposition may be used to form bond coat 14, 14a, or 14b. In some examples, a ceramic slurry may be prepared by dispersing reinforcing component 16 or 16b, and optional additional components, for example, one or more of chopped fiber, carbon, dispersant, binder, or solvents, in a liquid or flowable carrier. In some examples, the carrier may include at least one compatible solvent, including, for example, water, ethanol, isopropyl alcohol, methyl ethyl ketone, toluene, or the like. During the deposition and drying of the first slurry, the carrier material may be substantially removed (e.g., removed or nearly removed) from article 10, leaving behind the solid contents of the slurry (e.g. reinforcing component 16 or 16b).

Substrate 12 may include a slurry infiltrated preform, and the ceramic slurry may be deposited on substrate 12, for example, by dip or spray coating. In some examples, multiple layers of slurry including successively lower content of reinforcing content 16 or 16b, or a higher porosity, may be applied. The slurry coating may be dried, for example, removing the solvent. After drying the ceramic slurry coating, the coated component may be melt infiltrated by silicon metal or silicon alloy, with the silicon or silicon alloy infiltrating the dried slurry coating to form composite bond coat 14, 14a, or 14b including reinforcing component 16 or 16b and matrix 18. In some examples, depositing the slurry or the melt infiltration may be performed using any suitable mold.

In some examples, the slurry may include one or more optional additives. The additives may be used to tailor or alter the properties of the first slurry. For example, the one or more optional additives may include matrix precursors or other reactive elements that react with silicon metal or silicon alloy (e.g., carbon) during the melt infiltration process and contribute to the solid materials included in inner spaces 18. In some examples, the one or more optional additives may include a binder (e.g. polyethylene glycol, acrylate co-polymers, latex co-polymers, polyvinyl pyrrolidone co-polymers, polyvinyl butyral, or the like), a dispersant (e.g., ammonium polyacrylate, polyvinyl butyral, a phosphate ester, polyethylene imine, BYK® 110 (available from Byk USA, Inc., Wallingford Conn.), or the like), or the like. In some examples, other additives such as a surfactant (e.g., Dynol™ 607 surfactant available from Air Products) may be included in the slurry mixtures to improve wetting of the slurry.

Thus, example bond coats according to the disclosure may be formed by slurry deposition, infiltration, thermal spraying, or any suitable technique.

Various examples have been described. These and other examples are within the scope of the following claims.

What is claimed is:

1. A component comprising:
a substrate defining a major surface; and
a composite bond coat on the major surface of the substrate, wherein the composite bond coat comprises a matrix and a reinforcing component in the matrix, wherein the matrix is formed from silicon-based particles having an average particle size in a range from about 10 μm to about 30 μm, and wherein the reinforcing component comprises silicon-based ceramic particles having an average particle size in a range from about 5 μm to about 20 μm.

2. The component of claim 1, wherein the silicon-based ceramic particles comprise at least one of SiC or Si₃N₄.

3. The component of claim 1, wherein the silicon-based ceramic particles comprise substantially spheroidal particles.

4. The component of claim 3, wherein the silicon-based ceramic particles consist of substantially spheroidal particles.

5. The component of claim 1, wherein the silicon-based ceramic particles comprise crushed irregular particles.

6. The component of claim 1, wherein the composite bond coat comprises at least 50% by weight of the reinforcing component.

7. The component of claim 1, wherein the composite bond coat defines a thickness in a direction normal to a major surface of the substrate in a range from about 0.0127 mm (0.5 mils) to about 0.254 mm (10 mils).

8. The component of claim 1, wherein the composite bond coat comprises a graded distribution of the reinforcing component in the composite bond coat in a direction normal to and away from a major surface defined by the substrate, wherein a concentration of the reinforcing component is greater in a first region of the composite bond coat adjacent the major surface of the substrate than in a second region of the composite bond coat opposing the major surface.

9. The component of claim 1, further comprising at least one barrier layer on the composite bond coat, wherein the composite bond coat is between the substrate and the at least one barrier layer.

10. A method for forming a composite bond coat on a component, the method comprising:
introducing a precursor composition into a plume generated by a thermal spray gun to generate a thermal spray stream, wherein the precursor composition comprises a matrix component and a reinforcing component, wherein the matrix component comprises silicon-based particles having an average particle size in a range from about 10 μm to about 30 μm, and wherein the reinforcing component comprises silicon-based ceramic particles having an average particle size in a range from about 5 μm to about 20 μm; and
directing the thermal spray stream at a major surface defined by a substrate of the component to form the composite bond coat on the major surface.

11. The method of claim 10, wherein the silicon-based ceramic particles comprise at least one of SiC or Si₃N₄.

12. The method of claim 10, wherein the silicon-based ceramic particles comprise substantially spheroidal particles.

13. The method of claim 12, wherein the silicon-based ceramic particles consist of substantially spheroidal particles.

14. The method of claim 10, wherein the silicon-based ceramic particles comprise crushed irregular particles.

15. The method of claim 14, wherein the silicon-based ceramic particles consist of crushed irregular particles.

16. The method of claim 10, wherein the composite bond coat comprises at least 50% by weight of the reinforcing component.

17. The method of claim 10, further comprising successively reducing a volume fraction of the reinforcing component in the precursor composition to generate a graded distribution of the reinforcing component in the composite bond coat in a direction normal to and away from the substrate.

18. The method of claim 10, comprising at least one of air plasma spraying, low vapor plasma spraying, suspension plasma spraying, or high velocity oxygen fuel spraying.

19. The method of claim 10, further comprising depositing at least one barrier layer on the composite bond coat.

20. The method of claim 10, wherein the substrate comprises a ceramic matrix composite.
